(19) United States
(12) Patent Application Publication
(10) Pub. No.: US 2007/0121953 A1
(43) Pub. Date: May 31, 2007

(54) Audio decoding system and method

(75) Inventor: Hsing-Ju Wei, Kee-Lung City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Inc.

(21) Appl. No.: 11/287,742

(22) Filed: Nov. 28, 2005

(51) Int. Cl. H04R 5/00; G10L 21/00

(52) U.S. Cl. 381/22; 704/500

(57) ABSTRACT

A method and system for audio decoding. A set of channel remapping equations and channel remapping coefficients are first provided. Audio samples are received, which comprise a specific number of input channels In#. The audio samples are then processed according to the channel remapping equations and channel remapping coefficients, thereby converting the input channels In# to a specific number of output channels Out#.

### BACKGROUND

The invention relates to systems and methods for processing audio signals, and more particularly to systems and methods for processing audio signals according to a programmable channel remapping matrix.

A single AC-3 or MPEG-2 compliant audio bitstream may comprise up to five compressed channels and an uncompressed Low Frequency Effects (LFE) channel. Fewer channels, however, are commonly employed. A MPEG-1 bitstream comprises only one or two audio channels, and for backward compatibility, a MPEG-2 bitstream may employ a “downmixing process” to obtain information from the five channels into two channels such that the adequate audio information is available for MPEG-1 decoders. The left audio channel (L) may comprise mixed-in center (C) and left-surround (LS) channels, and the right audio channel (R) may comprise mixed-in center (C) and right-surround (RS) channels. The mixing coefficients and C, LS, and RS channels are comprised in the bitstream such that MPEG-2 decoders can reproduce the five channels individually.

Audio reproduction systems do not necessarily comprise the same number of speakers as encoded source audio channels, and consequently audio channel remapping or downmixing is required to adequately reproduce the effect of all audio channels over systems with different speaker configurations.

At least two of the distribution formats currently in use (MPEG-2 and Dolby AC-3) have provisions for channel remapping either at the encoding or the decoding side.

According to a method of related art, a set of downmix equations (downmix matrix) is provided. Channel downmixing can be performed using the downmix matrix. The downmix matrix can be used only in a channel downmixing configuration. When the number of output channels exceeds that of input channels, a case that does not belong to downmixing occurs, and the downmixing matrix cannot meet this requirement. Monaural output, however, is not included in the related-art downmix matrix. The related-art downmixing method cannot operate in applications implementing simultaneous downmix output channels. Additionally, when “1+1” input (dual monaural program) is provided, the related-art downmix matrix cannot be used to reproduce output channels compliant with the Dolby AC-3 standard.

### SUMMARY

Embodiments of the invention provide an audio decoding system capable of simultaneous downmixing, comprising an interface and a processor. The interface is configured to receive audio samples. The processor provides a set of channel remapping equations and coefficients, and processes the audio samples according to the channel remapping equations and channel remapping coefficients to convert a specific number of input channels In# to a specific number of output channels Out#, wherein Out6 and Out7 specify simultaneous downmix output channels, and the set of channel-remapping equations comprises:

$$[ \begin{matrix}Out 0 \\ Out 1 \\ Out 2 \\ Out 3 \\ Out 4 \\ Out 5 \\ Out 6 \\ Out 7\end{matrix} ] = [ \begin{matrix}a & g & w & b & c & 0 \\ x & k & 0 & i & j & 0 \\ y & v & d & e & f & 0 \\ 0 & 0 & 0 & m & 0 & 0 \\ 0 & 0 & 0 & n & q & 0 \\ 0 & 0 & 0 & 0 & 0 & p \\ {a}^{′} & {g}^{′} & 0 & {b}^{′} & {c}^{′} & 0 \\ {y}^{′} & {v}^{′} & {d}^{′} & {e}^{′} & {f}^{′} & 0\end{matrix} ] [ \begin{matrix}In 0 \\ In 1 \\ In 2 \\ In 3 \\ In 4 \\ In 5\end{matrix} ]$$

and a, b, c, d, e, f, g, i, j, k, m, n, p, q, v, w, x, y, a′, b′, c′, d′, e′, f′, g′, v′, y′, representing the channel remapping coefficients, are integers equal to or greater than zero.

Also disclosed is a multimedia decoding system capable of channel remapping, comprising an interface, a processor, a memory, a video decoder, and an audio decoder. The interface is configured to receive a multimedia bitstream. The processor parses the multimedia bitstream into video and audio data. The memory, coupled to the processor, stores the video data in a video data buffer, and stores the audio data in an audio data buffer. The video decoder, coupled to the memory, retrieves the video data and decodes the video data to generate digital video signals. The audio decoder, coupled to the memory, retrieves the audio data and decodes the audio data to generate a digital audio signal. Further, the audio decoder comprises an interface and a decoding processor. The interface receives the audio data from the audio data buffer. The processor provides a set of channel remapping equations and channel remapping coefficients, and processes the audio samples accordingly to convert a specific number of input channels In# to a specific number of output channels Out#, wherein the set of channel remapping equations comprises:

$$[ \begin{matrix}Out 0 \\ Out 1 \\ Out 2 \\ Out 3 \\ Out 4 \\ Out 5\end{matrix} ] = [ \begin{matrix}a & g & w & b & c & 0 \\ x & k & 0 & i & j & 0 \\ y & v & d & e & f & 0 \\ 0 & 0 & 0 & m & 0 & 0 \\ 0 & 0 & 0 & n & q & 0 \\ 0 & 0 & 0 & 0 & 0 & p\end{matrix} ] [ \begin{matrix}In 0 \\ In 1 \\ In 2 \\ In 3 \\ In 4 \\ In 5\end{matrix} ]$$

and a, b, c, d, e, f, g, i, j, k, m, n, p, q, v, w, x, y, representing the channel remapping coefficients, are integers equal to or greater than zero.

Also provided is a method implementing channel remapping, which comprises: receiving audio data, comprising a specified number of input channels In#; providing set of channel-remapping equations and channel remapping coefficients; processing the audio data according to the channel remapping equations, and converting the input audio data to a specific number of output channels Out#. The set of channel remapping equations comprises:

$$[ \begin{matrix}Out 0 \\ Out 1 \\ Out 2 \\ Out 3 \\ Out 4 \\ Out 5\end{matrix} ] = [ \begin{matrix}a & g & w & b & c & 0 \\ x & k & 0 & i & j & 0 \\ y & v & d & e & f & 0 \\ 0 & 0 & 0 & m & 0 & 0 \\ 0 & 0 & 0 & n & q & 0 \\ 0 & 0 & 0 & 0 & 0 & p\end{matrix} ] [ \begin{matrix}In 0 \\ In 1 \\ In 2 \\ In 3 \\ In 4 \\ In 5\end{matrix} ]$$

and a, b, c, d, e, f, g, i, j, k, m, n, p, q, v, w, x, y, representing the channel remapping coefficients, are integers equal to or greater than zero.

### DESCRIPTION OF THE DRAWINGS

The invention can be more fully understood by reading the subsequent detailed description and examples with references made to the accompanying drawings, wherein:

FIG. 1 is a schematic view of an embodiment of a multimedia playback system;

FIG. 2 is a simplified block diagram of a multimedia decoder;

FIG. 3A˜3C illustrate embodiments of a channel remapping matrix; and

FIG. 4 is a flowchart showing an embodiment of a channel remapping method.

### DETAILED DESCRIPTION

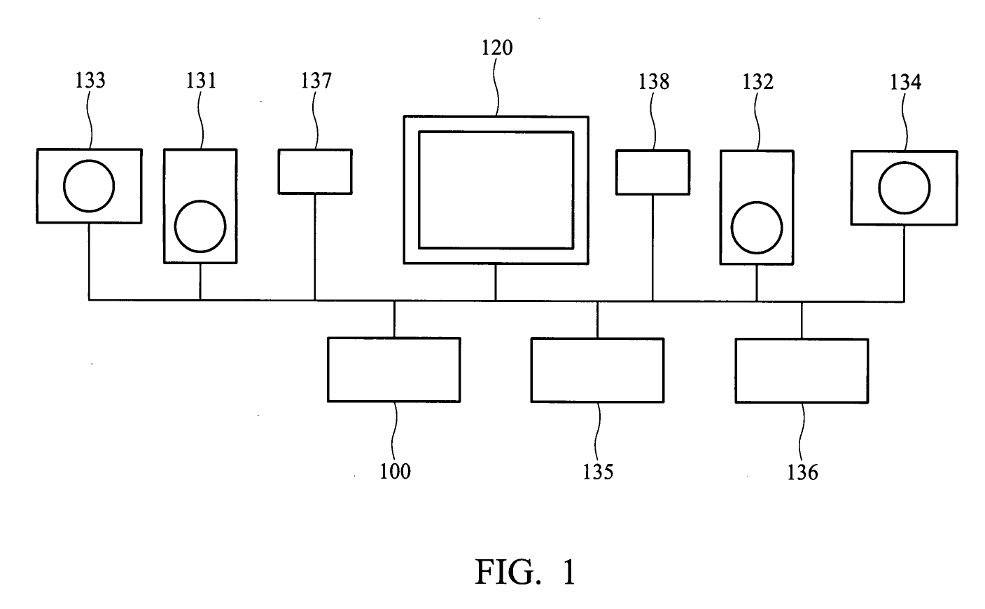

Embodiments of the invention are now described with reference to FIGS. 1 through 4, which generally relate to channel remapping. In the following detailed description, reference is made to the accompanying drawings which form a part hereof, and in which is shown by way of illustration of specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the present invention. The following detailed description is, therefore, not to be taken in a limiting sense, and the scope of the present invention is only defined by the appended claims. The leading digit(s) of reference numbers appearing in the Figures corresponds to the Figure number, with the exception that the same reference number is used throughout to refer to an identical component which appears in multiple Figures.

FIG. 1 is a schematic view of an embodiment of a multimedia playback system. A multimedia playback system 100 is connected to a display device 120 and speakers 131·138. The multimedia playback system 100 comprises a video decoder and an audio decoder (not shown in FIG. 1). The audio decoder provides programmable channel remapping equations and coefficients, which provides improved audio quality by means of reconfigurable channel remapping. The multimedia playback system 100 accepts discs in a disc drive and can read multimedia bitstreams from the disc. The multimedia playback system 100 converts the multimedia bit streams into video and audio signals, presents the video signals on the display device 120, and presents the audio signals using the speakers 131˜136.

The display device 120 can be, for example, a television set, computer monitor, LCD/LED flat panel display, or a projection system.

Speakers can be arranged in various configurations. For example, the speakers 131 and 132 can be a pair of left and right speakers, the speaker 135 can be a center speaker, the speakers 133 and 134 can be left and right surround speakers, and the speaker 136 can be a low frequency speaker. A single center speaker 135 can be provided. The left and right speakers 131 and 132 may be provided and used alone or in conjunction with the center speaker 135. The speakers 131˜133, and 135 can be provided in a left, right, surround, and center configuration. The speakers 131˜135 can be provided in a left, right, left surround, right surround, and center configuration. Additionally, the low-frequency speaker 136 can be provided in conjunction with any of the above configurations. The speakers 137 and 138 can be used for simultaneous downmix output channels, such as headphones and output speakers of a television set.

For example, the multimedia playback system 100 accepts an optical disc, which can be an audio compact disc, CD-ROM, DVD read-only, DVD rewriteable disc, or DVD-RAM. The multimedia playback system 100 reads and writes audio programs and multimedia bitstreams from and to the disc.

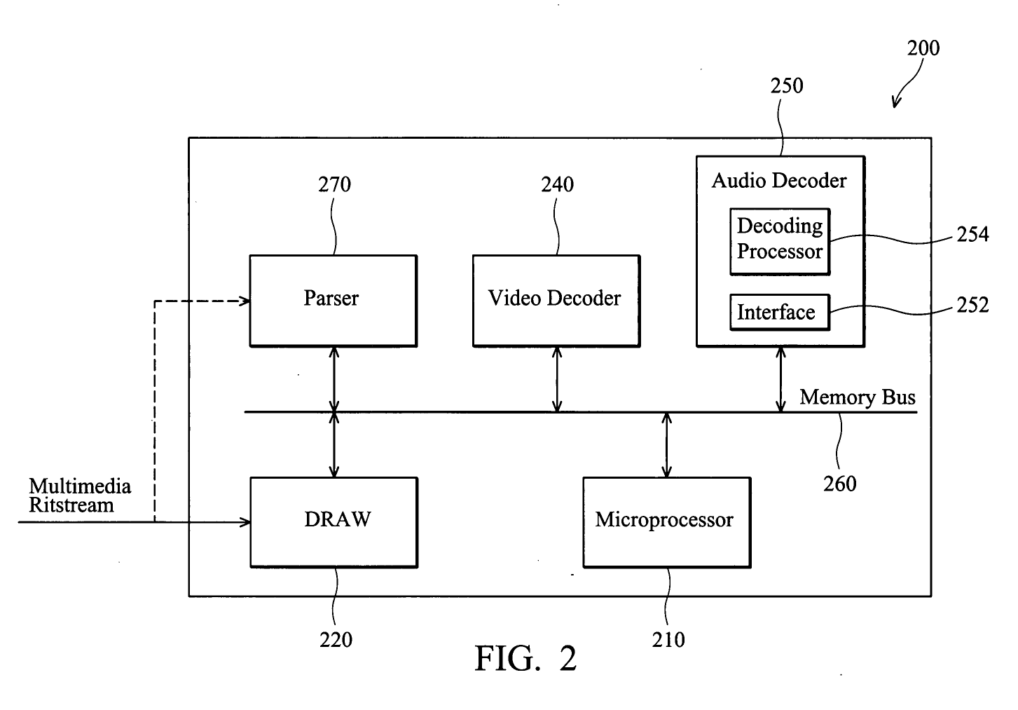

FIG. 2 illustrates a simplified block diagram of a multimedia decoder 200 implemented in the multimedia playback system 100 of FIG. 1. The multimedia decoder 200 operates to decode a multimedia bitstream to produce digital audio signals and video signals. The multimedia decoder 200 comprises a microprocessor 210, a dynamic random access memory (DRAM) 220, a video decoder 240, and an audio decoder 250. The microprocessor (or microcontroller) 210 operates to control other functional units of the multimedia decoder 200. The DRAM 220 temporarily stores the incoming multimedia bitstream. Optionally, the multimedia decoder 200 further comprises a hardware parser 270 operable to retrieve the multimedia bitstream through a memory bus 260 and parse the multimedia bitstream into video and audio data. As can be appreciated, the multimedia bitstream may be fed to the optional parser 270 directly. In some embodiments, the microprocessor 210 is instead responsible for parsing the multimedia bitstream into video and audio data, and then routing the video and audio data to appropriate buffers in the DRAM 220. The video decoder 240 retrieves the video data from a video buffer through the memory bus 260 and decodes the video data into a digital video signal. The audio decoder 250 retrieves the audio data from an audio buffer through the memory bus 260 and decodes the audio data into a digital video signal. Furthermore, the audio decoder 250 operates to perform channel remapping, which is detailed below. The digital audio signal and video signals may be converted to analog audio and video signals and then sent to the display device 120 and the speakers 131˜136.

Here, the audio bitstream conforms to either or both of the MPEG-2 and AC-3 standards. According to the MPEG and AC-3 standards, only a basic framework of the audio encoding process is defined, and each encoding implementation can have its own algorithmic optimizations.

An AC-3 audio encoding process may comprise steps of locking the input sampling rate to the output bit rate, sample rate conversion, input filtering, transient detection, forward transforming, channel coupling, rematrixing, exponent extraction, dithering strategy, encoding of exponents, mantissa normalization, bit allocation, quantization of mantissas, and packing of AC-3 audio frames. Similarly, MPEG audio encoding involves the steps of filter bank synthesis (includes windowing, matrixing, and time-to-frequency domain mapping), calculation of signal to noise ratio, bit or noise allocation for audio samples, scale factor calculation, sample quantization, and formatting of the output bitstream. For either method, the audio compression may further include subsampling of low frequency signals, adaptation of frequency selectivity, and error correction coding.

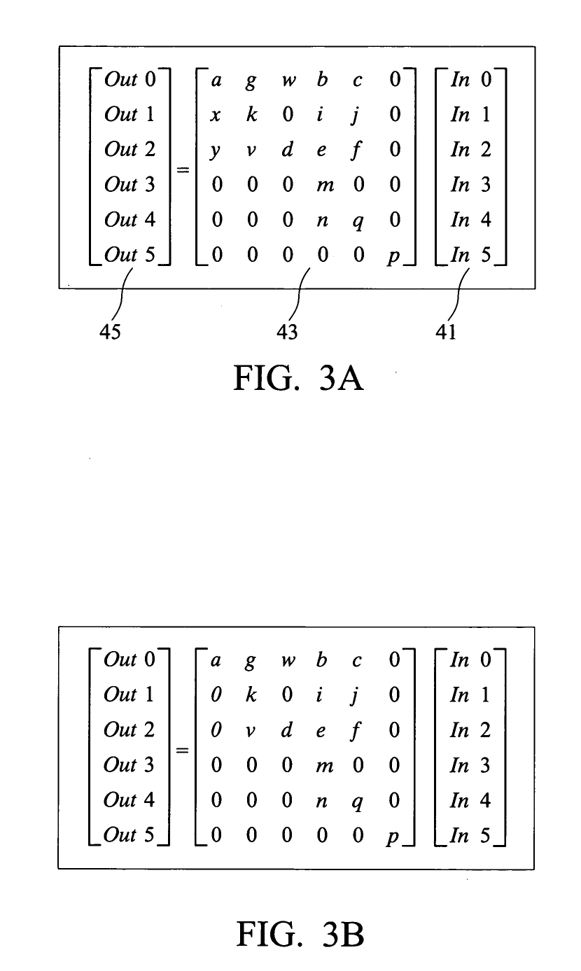

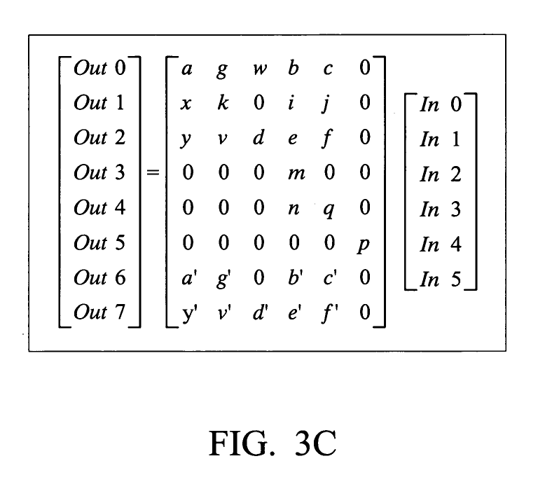

The audio decoder 250 comprises an interface 252 and a decoding processor 254. The interface 252 is configured to receive audio samples through the memory bus 260. The processor 254 provides a set of channel remapping equations and coefficients for use in these equations, and processes the audio samples according to the channel remapping equations and coefficients to convert a specific number of input channels In# to a specific number of output channels Out#. The channel remapping equations, shown in FIGS. 3A˜3C, are used for channel remapping for one to eight output channels, where a, b, c, d, e, f, g, i, j, k, m, n, p, q, v, w, x, y, a′, b′, c′, d′, e′, f′, g′, v′, y′ representing channel-remapping coefficients, are integers equal to or greater than zero. The channel-remapping coefficients can be defined by a user, or specified by the multimedia bistream in which an output mode indicates which output channels are desired. As such, the decoding processor 254 determines these coefficients according to the multimedia bitstream or user definition. In some embodiments, the microprocessor 210 can be employed to program the channel-remapping coefficients.

Referring to FIG. 3A, a set of input channels 41 is processed according to a set of channel remapping coefficients 43 to produce a set of output channels 45. Coefficients for certain channel remapping configurations may be specified in the bitstream, and may be used as default values by audio decoder 250. The channel remapping matrix can be used for various speaker configurations, and the channel remapping coefficients are programmable for balance control of output channels.

In FIG. 3A and the embodiments provided here, if not assigned specifically, the input channels In0˜In5 specify left (L), center (C), right (R), left surround (LS), right surround (RS), low-frequency (LFE) input channels, respectively. Additionally, the output channels Out0˜Out5 specify left (L), center (C), right (R), left surround (LS), right surround (RS), low-frequency (LFE) output channels, respectively.

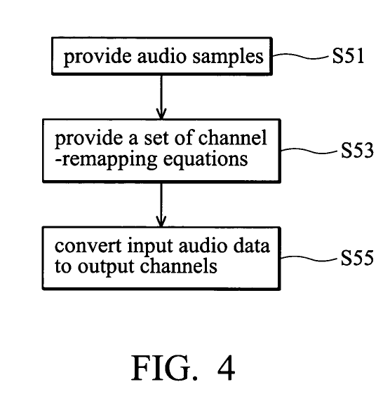

Referring to FIG. 4, a flowchart of an embodiment of a channel remapping method is shown. Audio samples are provided, comprising a specific number of input channels In# (step S51) A set of channel-remapping equations is provided in step S53. The audio samples are scaled and added according to the remapping equations. The input audio data is then converted to a specific number of output channels Out# in step S55.

The set of channel remapping equations provided in FIGS. 3A˜3C can be used for channel remapping for one to eight output channels. Examples of the use of this set of equations are described.

For example, for a single monaural output channel, coefficients d, e, f, i, j, k, m, q, p, and v are set to zero, and other coefficients are non-zero integers. The set of channel remapping equations is shown in FIG. 3A. The channel remapping equation is as follows:
Out0=a×In0+g×In1+w×In2+b×In3+c×In4

When a dual monaural program is provided (hereinafter referred to as a “1+1” input), a channel remapping process conforming to the Dolby standard can be performed using the channel remapping matrix shown in FIG. 3B, deriving from the channel remapping equations shown in FIG. 3A. Here, two monaural source channels (Ch1 and Ch2) are provided and presented to three speaker configuration (3/0 output), where In0=Ch1, and In1=Ch2.

When the two monaural source channels are provided to a stereo output, coefficients a and v are set to 1, and other coefficients are set to zero. Therefore, output left and right channels are determined as follows.
Out0(L′)=Ch1
Out2(R′)=Ch2

When the two monaural source channels are provided to a Ch1 monaural output, coefficient x is set to 1, and other coefficients are set to zero. Therefore, the output center channel is determined as follows.
Out1(C′)=Ch1

When the two monaural source channels are provided to a Ch2 monaural output, coefficient k is set to 1, and other coefficients are set to zero. Therefore, the output center channel is determined as follows.
Out1(C′)=Ch2

When the two monaural source channels are provided to a mixed monaural output, coefficients x and k are set to 0.5, and other coefficients are set to zero. Therefore, the output center channel is determined as follows.
Out1(C′)=0.5×Ch1+0.5×Ch2

The values for the non-zero mixing coefficients are present in the bitstream, and may be individually programmed.

The channel remapping equations shown in FIG. 3C can be used for simultaneous downmixing. The output channels Out6 and Out7 specify simultaneous downmix output channels. In light of the equations of FIG. 3C, Left (IN0), center (IN1), right (IN2), left surround (IN3), and right surround (IN4) input channels are mixed down to two simultaneous output channels by:
Out6=a′×In0+g′×In1+b′×In3+c′×In4
and
Out7=y′×In0+v′×In1+d′×In2+e′×In3+f′×In4,
which are different from the normal downmixing of the form:
Out0=a×In0+g×In1+w×In2+b×In3+c×In4
and
Out2=y×In0+v×In1+d×In2+e×In3+f×In4.

Furthermore, the channel remapping matrix illustrated in FIGS. 3A˜3C can also be used in non-downmix cases. A 3/1 input vs. 3/2 output configuration is exemplified here. Here, In0=L, In1=C, In2=R, and single surround channel (S) is In3. For the described channel remapping process, coefficients a, k, and d are set to 1, coefficients m and n are set to 0.707 (1/\sqrt{2}), and other coefficients are set to zero. Therefore, output channels are determined as follows.
Out0(L′)=L
Out1(C′)=C
Out2(R′)=R
Out3(Ls′)=0.707×S
Out4(Rs′)=0.707×S

These examples illustrate the flexibility of the standardized set of channel remapping equations.

Note that any source channel contribution to a particular output channel can be made zero by programming the corresponding channel remapping coefficient to be zero. An output channel can be completely “zeroed out” by programming all the channel remapping coefficients in the corresponding equation to be zero.

For Out0˜Out4, when the input channel configuration matches the output channel configuration, coefficients a, k, d, m, q are set to 1 and coefficients b, c, e, f, g, i, j, n, v, w, x, y are set to zero. In this case, the input audio samples are copied directly to the output buffers.

While the invention has been described by way of example and in terms of the preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. An audio decoding system, comprising:
an interface receiving audio samples; and
a processor providing a set of channel remapping equations and channel remapping coefficients, and processing the audio samples according to the channel remapping equations and channel remapping coefficients to convert a specific number of input channels In# to a specific number of output channels Out#, wherein Out6 and Out7 specify simultaneous downmix output channels, and the set of channel-remapping equations comprises:
$$[ \begin{matrix}Out 0 \\ Out 1 \\ Out 2 \\ Out 3 \\ Out 4 \\ Out 5 \\ Out 6 \\ Out 7\end{matrix} ] = [ \begin{matrix}a & g & w & b & c & 0 \\ x & k & 0 & i & j & 0 \\ y & v & d & e & f & 0 \\ 0 & 0 & 0 & m & 0 & 0 \\ 0 & 0 & 0 & n & q & 0 \\ 0 & 0 & 0 & 0 & 0 & p \\ {a}^{′} & {g}^{′} & 0 & {b}^{′} & {c}^{′} & 0 \\ {y}^{′} & {v}^{′} & {d}^{′} & {e}^{′} & {f}^{′} & 0\end{matrix} ] [ \begin{matrix}In 0 \\ In 1 \\ In 2 \\ In 3 \\ In 4 \\ In 5\end{matrix} ]$$
and wherein a, b, c, d, e, f, g, i, j, k, m, n, p, q, v, w, x, y, a′, b′, c′, d′, e′, f, g′, v′, y′ represent the channel remapping coefficients.

2. The system of claim 1, wherein the specific number of output channels is user-configurable, corresponding to an audio system playback capability, each of which corresponds to a subset of the channel remapping equations.

3. The system of claim 1, wherein the specific number of input channels is user-configurable.

4. The system of claim 1, wherein the channel remapping coefficients are determined according to parameters specified in an input audio bitstream.

5. The system of claim 1, wherein the channel remapping coefficients are user-configurable.

6. The system of claim 1, wherein the channel remapping coefficients are programmable for balance control of output channels.

7. The system of claim 1, wherein the channel remapping coefficients are programmable to allow a given number of input audio channels to be remapped to one to eight output audio channels.

8. A multimedia decoding system, comprising:
an interface receiving a multimedia bitstream;
a processor parsing the multimedia bitstream into video and audio data;
a memory, coupled to the processor, storing the video data in a video data buffer, and storing the audio data stream in an audio data buffer;
a video decoder, coupled to the memory, retrieving the video data and decoding the video data to generate a digital video signal; and
an audio decoder, coupled to the memory, retrieving the audio data and decoding the audio data to generate a digital audio signal, the audio decoder comprising:
an interface receiving the audio data from the audio data buffer; and
a decoding processor providing a set of channel remapping equations and channel remapping coefficients, and processing the audio samples according to the channel remapping equations and channel remapping coefficients to convert a specific number of input channels In# to a specific number of output channels Out#, wherein the set of channel-remapping equations comprises:
$$[ \begin{matrix}Out 0 \\ Out 1 \\ Out 2 \\ Out 3 \\ Out 4 \\ Out 5\end{matrix} ] = [ \begin{matrix}a & g & w & b & c & 0 \\ x & k & 0 & i & j & 0 \\ y & v & d & e & f & 0 \\ 0 & 0 & 0 & m & 0 & 0 \\ 0 & 0 & 0 & n & q & 0 \\ 0 & 0 & 0 & 0 & 0 & p\end{matrix} ] [ \begin{matrix}In 0 \\ In 1 \\ In 2 \\ In 3 \\ In 4 \\ In 5\end{matrix} ]$$
and wherein a, b, c, d, e, f, g, i, j, k, m, n, p, q, v, w, x, y represent the channel remapping coefficients.

9. The system of claim 8, wherein when the specific number of output channels is one, the channel remapping coefficients d, e, f, i, j, k, m, n, p, q, v, x and y are set to zero, such that the decoding processor downmixes the input channels to a monaural output channel by:
Out0=a×In0+g×In1+w×In2+b×In3+c×In4.

10. The system of claim 8, wherein the decoding processor determines the channel remapping coefficients according to the multimedia bitstream.

11. The system of claim 10, wherein the decoding processor determines the channel remapping coefficients according to a specified output mode indicating which output channels are desired.

12. The system of claim 8, wherein the decoding processor determines the channel remapping coefficients according to a user definition.

13. A method of channel remapping, comprising:
receiving audio samples, comprising a specific number of input channels In#;
providing a set of channel remapping equations and channel remapping coefficients;
processing the audio samples according to the channel remapping equations and the channel remapping coefficients, and converting the input audio data to a specific number of output channels Out#, wherein the set of channel remapping equations comprises:
$$[ \begin{matrix}Out 0 \\ Out 1 \\ Out 2 \\ Out 3 \\ Out 4 \\ Out 5\end{matrix} ] = [ \begin{matrix}a & g & w & b & c & 0 \\ x & k & 0 & i & j & 0 \\ y & v & d & e & f & 0 \\ 0 & 0 & 0 & m & 0 & 0 \\ 0 & 0 & 0 & n & q & 0 \\ 0 & 0 & 0 & 0 & 0 & p\end{matrix} ] [ \begin{matrix}In 0 \\ In 1 \\ In 2 \\ In 3 \\ In 4 \\ In 5\end{matrix} ]$$
and wherein a, b, c, d, e, f, g, i, j, k, m, n, p, q, v, w, x, y represent the channel remapping coefficients.

14. The method of claim 13, wherein when the specific number of output channels is one, the channel remapping coefficients d, e, f, i, j, k, m, n, p, q, v, x and y are set to zero, such that the input channels are downmixes to a monaural output channel by:
Out0=a×In0+g×In1+w×In2+b×In3+c×In4.

15. The method of claim 13, wherein the specific number of output channels is user-configurable, corresponding to the playback capability of an audio system, each of which corresponds to a subset of the channel remapping equations.

16. The method of claim 13, wherein the specific number of input channels is user-configurable.

17. The method of claim 13, wherein the channel remapping coefficients are determined according to parameters specified in an input audio bitstream.

18. The method of claim 13, wherein the channel remapping coefficients are user-configurable.

19. The method of claim 13, wherein the channel remapping coefficients are programmable for balance control of output channels.

20. The method of claim 13, wherein the channel remapping coefficients are programmable to allow a given number of input audio channels to be remapped to one to eight output audio channels.
